(19) United States
(12) Patent Application Publication
(10) Pub. No.: US 2009/0085540 A1
(43) Pub. Date: Apr. 2, 2009

(54) Voltage Rising/Falling Type Switching Regulator and Reverse Current Prevention Method

(76) Inventor: Junji Nishida, Osaka (JP)

Correspondence Address: DICKSTEIN SHAPIRO LLP, 1825 EYE STREET NW, Washington, DC, 20006-5403, US

(21) Appl. No.: 12/224,560

(22) PCT Filed: Jan. 16, 2008
(86) PCT No.: PCT/JP2008/050839

§ 371 Date: Aug. 29, 2008

(30) Foreign Application Priority Data
Jan. 22, 2007 (JP) 2007-011074

(51) Int. Cl. G05F 1/00

(52) U.S. Cl. 323/282

(57) ABSTRACT

A voltage rising/falling type switching regulator includes an inductor, a voltage-falling switching element, a voltage-falling rectifier element, a voltage-rising switching element, a voltage-rising synchronous rectification switching element, a control circuit part, and a reverse current detecting part. The control circuit part is arranged so that the voltage-falling switching element is switched ON and set in a conduction state at the time of voltage-rising operation, and the voltage-rising synchronous rectification switching element is switched ON and set in a conduction state at the time of voltage-falling operation. If the reverse current detecting part detects a reverse current, the voltage-falling switching element is switched OFF and set in a cut-off state.

### TECHNICAL FIELD

This invention generally relates to a reverse current prevention circuit of a voltage rising/falling type switching regulator, and in particular to a circuit for preventing a reverse current in a voltage rising/falling type switching regulator which operates in a discontinuous mode.

### BACKGROUND ART

FIG. 5 shows the composition of a conventional voltage rising/falling type switching regulator.

In the voltage rising/falling type switching regulator of FIG. 5, when the input voltage Vin is above the output voltage Vo, switching ON/OFF control of a PMOS transistor M101 is performed in response to a control signal from a control circuit 120, so that the level of the input voltage Vin is loared to a predetermined voltage and the resulting voltage is outputted from the output terminal Vout. At this time, an NMOS transistor M103 is switched OFF in response to a control signal from the control circuit 120 and the transistor M103 is in a cut-off state.

When the input voltage Vin is lower than the output voltage Vo, switching ON/OFF control of the NMOS transistor M103 is performed according to a control signal from the control circuit 120, so that the level of the input voltage Vin is raised to a predetermined voltage and the voltage is outputted from the output terminal Vout. At this time, the PMOS transistor M101 is switched ON in response to a control signal from the control circuit 120 and the transistor M101 is in a conduction state.

A diode D101 is a rectifier diode for supplying electric power from the ground voltage to the output terminal Vout via an inductor L101 when the PMOS transistor M101 is switched OFF at the time of voltage-falling operation.

A diode D102 is a rectifier diode for preventing a reverse current from flowing backwards from the output terminal Vout to the input voltage Vin at the time of voltage-rising operation.

Since the voltage rising/falling type switching regulator of FIG. 5 uses the diodes D101 and D102 as a rectifier element, the efficiency of power conversion is not adequately good. This is because the forward voltage of the diodes is high and the voltage loss caused by rectification is large due to use of the diodes.

To obviate the problem, a voltage rising/falling type switching regulator of synchronous rectification in which the diodes D101 and D102 are replaced with MOS transistors has been proposed, in order to reduce the voltage loss caused by rectification.

FIG. 6 shows the composition of a conventional voltage rising/falling type switching regulator utilizing synchronous rectification. For example, refer to Japanese Laid-Open Patent Application No. 2002-314076.

In the voltage rising/falling type switching regulator of FIG. 6, the diode D101 of FIG. 5 is replaced with an NMOS transistor M102, and the diode D102 of FIG. 5 is replaced with a PMOS transistor M104, respectively.

The NMOS transistor M102 is synchronized with the PMOS transistor M101, and the voltage-falling control is carried out by performing switching ON/OFF control of the NMOS transistor M102 and the PMOS transistor M101 complementarily. The PMOS transistor M104 is synchronized with the NMOS transistor M103, and the voltage rising control is carried out by performing switching ON/OFF control of the NMOS transistor M103 and the PMOS transistor M104 complementarily.

When an input signal Vz1 is at high level, the PMOS transistor M101 is switched ON and the NMOS transistor M102 is switched OFF. When the input signal Vz1 is at low level, the PMOS transistor M101 is switched OFF and the NMOS transistor M102 is switched ON.

Similarly, when an input signal Vz2 is at high level, the NMOS transistor M103 is switched ON and the PMOS transistor M104 is switched OFF. When the input signal Vz2 is at low level, the NMOS transistor M103 is switched OFF and the PMOS transistor M104 is switched ON.

When the input voltage Vin is above the output voltage Vo, the input signal Vz2 is set to the low level, the NMOS transistor M103 is switched OFF and the PMOS transistor M104 is switched ON. In this state, the input signal Vz1 is alternately switched to one of the high level and the low level, so that switching ON/OFF control of the PMOS transistor M101 and the NMOS transistor M102 is carried out. By using the logic circuit in the control circuit 130, switching ON the PMOS transistor M101 and the NMOS transistor M102 simultaneously is avoided.

When the input voltage Vin is lower than the output voltage Vo, the input signal Vz1 is set to the high level, so that the PMOS transistor M101 is switched ON and the NMOS transistor M102 is switched OFF. In this state, the input signal Vz2 is alternately switched to one of the high level and the low level, so that switching ON/OFF control of the NMOS transistor M103 and the PMOS transistor M104 is performed. By using the logic circuit in the control circuit 130, switching ON the NMOS transistor M103 and the PMOS transistor M104 simultaneously is avoided.

In the composition of FIG. 6, the MOS transistors are used as the rectifier elements, the voltage drop by rectification can be remarkably reduced from that in the case where the diodes are used, and it is possible to increase the efficiency of power conversion greatly.

Generally, a voltage rising/falling type switching regulator operates in either a continuous mode or a discontinuous mode. When it operates in the continuous mode, the current flows through the inductor L101 continuously. However, when it operates in the discontinuous mode, the current does not flow through the inductor L101 continuously.

The current which flows through the inductor L101 becomes small as the load current becomes small. The energy accumulated in the inductor L101 in such a state becomes small. The switching regulator may be set in a state in which the switching transistor (which is the PMOS transistor M101 at the time of voltage-falling operation and the NMOS transistor M103 at the time of voltage-rising operation) is switched OFF, during one cycle of switching operation, whereas the current supplied from the inductor L101 to the load is set to 0 (zero) A. In the following, the above-mentioned state will be called the discontinuous mode.

When the switching regulator is operating in the discontinuous mode, the voltage at one end of the inductor L101 on the side of the input voltage Vin may be smaller than the voltage Vo at the other end of the inductor L101 near the output terminal Vout. In the case of the composition of FIG. 5, a reverse current flowing from the output terminal Vout into the inductor L101 does not occur because of the use of the diode D102. However, in the case of the composition of FIG. 6, the PMOS transistor M104 is switched ON and a reverse current flowing from the output terminal Vout into the inductor L101 may occur. Occurrence of such a reverse current causes the efficiency of power conversion to fall extremely.

### DISCLOSURE OF THE INVENTION

According to one aspect of the invention, there is disclosed an improved switching regulator in which the above-described problems are eliminated.

According to one aspect of the invention there is disclosed a voltage rising/falling type switching regulator which uses MOS transistors as rectifier elements and is arranged with simple circuit composition to prevent occurrence of a reverse current effectively.

According to one aspect of the invention there is disclosed a reverse current prevention method of a voltage rising/falling type switching regulator which uses MOS transistors as rectifier elements and is arranged with simple circuit composition to prevent occurrence of a reverse current effectively.

In an embodiment of the invention which solves or reduces one or more of the above-mentioned problems, there is disclosed a voltage rising/falling type switching regulator which changes an input voltage from an input terminal to a predetermined voltage through voltage rising/falling operation using an inductor and outputs a resulting voltage from an output terminal, the voltage rising/falling type switching regulator comprising: a voltage-falling switching element which is switched in response to a control signal to perform voltage-falling operation and charge the inductor by the input voltage; a voltage-falling rectifier element which discharges the inductor to perform voltage-falling operation; a voltage-rising switching element which is switched in response to a control signal to perform voltage-rising operation and charge the inductor by the input voltage; a voltage-rising synchronous rectification switching element which is switched in response to a control signal to perform voltage-rising operation and discharge the inductor; a control circuit part causing the voltage-falling switching element to be switched to perform voltage-falling operation, and causing the voltage-rising switching element and the voltage-rising synchronous rectification switching element to be switched to perform voltage-rising operation, so as to set the resulting voltage from the output terminal to the predetermined voltage; and a reverse current detecting part detecting a reverse current which flows backward from the output terminal to the voltage-rising synchronous rectification switching element, wherein the control circuit part is arranged so that the voltage-falling switching element is switched ON and set in a conduction state at the time of voltage-rising operation, the voltage-rising synchronous rectification switching element is switched ON and set in a conduction state at the time of voltage-falling operation, and, if the reverse current detecting part detects the reverse current, the voltage-falling switching element is switched OFF and set in a cut-off state.

The above-mentioned voltage rising/falling type switching regulator may be configured so that the voltage-falling switching element is an MOS transistor, a first switching element is provided to make connection between the input voltage and a substrate gate of the MOS transistor, and the control circuit part is arranged to switch the first switching element OFF and set the first switching element in a cut-off state if the reverse current detecting part detects the reverse current.

The above-mentioned voltage rising/falling type switching regulator may be configured so that the first switching element is an MOS transistor of a type which is the same as a type of the voltage-falling switching element.

The above-mentioned voltage rising/falling type switching regulator may be configured so that the voltage-rising synchronous rectification switching element is an MOS transistor, and the reverse current detecting part detects the reverse current based on a voltage difference between two ends of the MOS transistor.

The above-mentioned voltage rising/falling type switching regulator may be configured so that the voltage-falling rectifier element is a diode.

The above-mentioned voltage rising/falling type switching regulator may be configured so that the voltage-falling rectifier element is a voltage-falling synchronous rectification switching element which is switched in response to a control signal to perform voltage-falling operation and discharge the inductor, and the control circuit part is arranged to cause the voltage-falling switching element and the voltage-falling synchronous rectification switching element to be switched to perform voltage-falling operation, so as to set the resulting voltage from the output terminal to the predetermined voltage, and, if the reverse current detecting part detects the reverse current, the voltage-falling synchronous rectification switching element is switched OFF and set in a cut-off state.

The above-mentioned voltage rising/falling type switching regulator may be configured so that the voltage-falling rectifier element is a voltage-falling synchronous rectification switching element which is switched in response to a control signal to perform voltage-falling operation and discharge the inductor, and a second switching element is connected in series to the voltage-falling synchronous rectification switching element and switched in response to a control signal inputted to a control electrode, and the control circuit part is arranged so that, if the reverse current detecting part detects the reverse current, the second switching element is switched OFF and set in a cut-off state.

The above-mentioned voltage rising/falling type switching regulator may be configured so that the control circuit part comprises: an error amplifier part which outputs an amplified signal of a voltage difference between a proportional voltage proportional to the resulting voltage from the output terminal, and a predetermined reference voltage; an inverted amplifier part which outputs an inverted amplified signal of an output signal from the error amplifier part; and an output control circuit part which causes the voltage-falling switching element to be switched in response to the output signal from the error amplifier part to perform voltage-falling operation, and causes the voltage-rising switching element and the voltage-rising synchronous rectification switching element to be switched in response to the output signal from the error amplifier part to perform voltage-rising operation, so as to set the resulting voltage from the output terminal to the predetermined voltage.

The above-mentioned voltage rising/falling type switching regulator may be configured so that the control circuit part comprises: an error amplifier part which outputs an amplified signal of a voltage difference between a proportional voltage proportional to the resulting voltage from the output terminal, and a predetermined reference voltage; an inverted amplifier part which outputs an inverted amplified signal of an output signal from the error amplifier part; and an output control circuit part which causes the voltage-falling switching element and the voltage-falling synchronous rectification switching element to be switched in response to the output signal from the error amplifier part to perform voltage-falling operation, and causes the voltage-rising switching element and the voltage-rising synchronous rectification switching element to be switched in response to the output signal from the error amplifier part to perform voltage-rising operation, so as to set the resulting voltage from the output terminal to the predetermined voltage.

The above-mentioned voltage rising/falling type switching regulator may be configured so that the output control circuit part is arranged so that, when an output voltage of the error amplifier part and an output voltage of the inverted amplifier part are equal to each other, the output control circuit part controls switching of the voltage-falling switching element and the voltage-rising switching element so as to set an on-duty cycle of the voltage-falling switching element to 100% and set an on-duty cycle of the voltage-rising switching element to 0%.

The above-mentioned voltage rising/falling type switching regulator may be configured so that the output control circuit part comprises: a triangular wave oscillator which generates and outputs a predetermined triangular wave signal; a voltage-falling output control circuit which controls switching of the voltage-falling switching element based on a result of comparison between the triangular wave signal and the output signal from the error amplifier part; a voltage-rising output control circuit which controls switching of the voltage-rising switching element and the voltage-rising synchronous rectification switching element, respectively, based on a result of comparison between the triangular wave signal and the output signal from the inverted amplifier part; wherein, when the output voltage of the error amplifier part and the output voltage of the inverted amplifier part are equal to each other, the output voltage of each amplifier part exceeds an upper limit voltage of the triangular wave signal.

The above-mentioned voltage rising/falling type switching regulator may be configured so that the inverted amplifier part comprises a shift voltage generating circuit generating a predetermined shift voltage which is applied to an output signal which is inverted and amplified.

The above-mentioned voltage rising/falling type switching regulator may be configured so that the voltage-falling switching element, the voltage-falling rectifier element, the voltage-rising switching element, the voltage-rising synchronous rectifier element, the control circuit part, and the reverse current detecting part are integrated on a single IC.

In an embodiment of the invention which solves or reduces one or more of the above-mentioned problems, there is disclosed a reverse current prevention method of a voltage rising/falling type switching regulator which changes an input voltage from an input terminal to a predetermined voltage through voltage rising/falling operation using an inductor and outputs a resulting voltage from an output terminal, the voltage rising/falling type switching regulator including: a voltage-falling switching element which is switched in response to a control signal to perform voltage-falling operation and charge the inductor by the input voltage; a voltage-falling rectifier element which discharges the inductor to perform voltage-falling operation; a voltage-rising switching element which is switched in response to a control signal to perform voltage-rising operation and charge the inductor by the input voltage; and a voltage-rising synchronous rectification switching element which is switched in response to a control signal to perform voltage-rising operation and discharge the inductor; wherein the voltage-falling switching element is switched to perform voltage-falling operation, and the voltage-rising switching element and the voltage-rising synchronous rectification switching element are switched to perform voltage-rising operation, so as to set the resulting voltage from the output terminal to the predetermined voltage, the reverse current prevention method comprising: switching ON the voltage-falling switching element to set the voltage-falling switching element in a conduction state at the time of voltage-rising operation; switching ON the voltage-rising synchronous rectification switching element to set the voltage-rising synchronous rectification switching element in a conduction state at the time of voltage-falling operation; detecting a reverse current which flows backward from the output terminal to the voltage-rising synchronous rectification switching element; and switching OFF the voltage-falling switching element and setting the voltage-falling switching element in a cut-off state, if the reverse current is detected.

The above-mentioned reverse current prevention method may be configured so that the voltage-falling rectifier element is a voltage-falling synchronous rectification switching element which is switched in response to a control signal to perform voltage-falling operation and discharge the inductor, and, if the reverse current is detected, the voltage-falling switching element and the voltage-falling synchronous rectification switching element are switched OFF and set in a cut-off state respectively.

The above-mentioned reverse current prevention method may be configured so that the voltage-falling rectifier element is a voltage-falling synchronous rectification switching element which is switched in response to a control signal to perform voltage-falling operation and discharge the inductor, and a second switching element is connected in series to the voltage-falling synchronous rectification switching element and switched in response to a control signal inputted to a control electrode, and, if the reverse current is detected, the voltage-falling switching element and the second switching element are switched OFF and set in a cut-off state.

The above-mentioned reverse current prevention method may be configured so that the voltage-falling switching element is an MOS transistor, a first switching element is provided to make connection between the input voltage and a substrate gate of the MOS transistor, and, if the reverse current is detected, the first switching element is switched OFF and set in a cut-off state.

The above-mentioned reverse current prevention method may be configured so that the voltage-rising synchronous rectification switching element is an MOS transistor and the reverse current is detected based on a voltage difference between two ends of the MOS transistor.

According to the embodiment of the invention, it is possible to provide a voltage rising/falling type switching regulator which uses MOS transistors as rectifier elements and is arranged with simple circuit composition to prevent occurrence of a reverse current effectively.

### BRIEF DESCRIPTION OF THE DRAWINGS

Other objects, features and advantages of the present invention will be apparent from the following detailed description when reading in conjunction with the accompanying drawings.

FIG. 1 is a circuit diagram showing the composition of a voltage rising/falling type switching regulator in an embodiment of the invention.

FIG. 2 is a timing chart for explaining operation of the voltage rising/falling type switching regulator of FIG. 1.

FIG. 3 is a circuit diagram showing the composition of a voltage rising/falling type switching regulator in an embodiment of the invention.

FIG. 4 is a circuit diagram showing the composition of a voltage rising/falling type switching regulator in an embodiment of the invention.

FIG. 5 is a circuit diagram showing the composition of a conventional voltage rising/falling type switching regulator.

FIG. 6 is a circuit diagram showing the composition of a conventional voltage rising/falling type switching regulator.

### BEST MODE FOR CARRYING OUT THE INVENTION

A description will be given of embodiments of the invention with reference to the accompanying drawings.

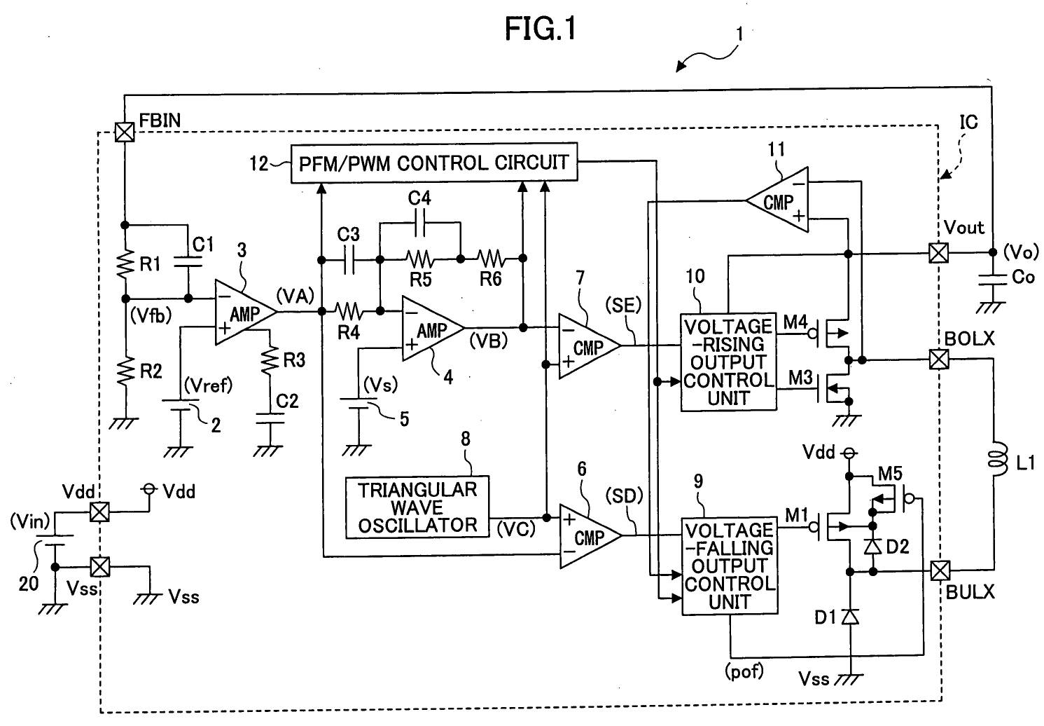

FIG. 1 is a circuit diagram showing the composition of a voltage rising/falling type switching regulator in an embodiment of the invention. As shown in FIG. 1, the voltage rising/falling type switching regulator 1 changes an input voltage Vin, which is supplied from a direct-current power supply 20 to an input terminal Vdd, to a predetermined voltage through voltage rising/falling operation, and outputs a resulting voltage from an output terminal Vout as an output voltage Vo.

The voltage rising/falling type switching regulator 1 includes: resistors R1, R2 which generate a proportional voltage Vfb proportional to the output voltage Vo; a capacitor C1; a reference-voltage generating circuit 2 which generates and outputs a predetermined reference voltage Vref; an error amplifier which includes an operational amplifier 3, a resistor R3 and a capacitor C2; and an inverted amplifier which includes an operational amplifier 4, resistors R4-R6, capacitors C3, C4, and a voltage generating circuit 5 which generates and outputs a predetermined shift voltage Vs.

The voltage rising/falling type switching regulator 1 further includes a voltage-falling PWM comparator 6, a voltage-rising PWM comparator 7, a triangular wave oscillator 8 which generates and outputs a predetermined triangular wave voltage VC, a voltage-falling output control circuit 9, a voltage-rising output control circuit 10, a voltage-falling switching transistor M1 using a PMOS transistor, a voltage-falling rectifier diode D1, a voltage-rising switching transistor M3 using an NMOS transistor, a voltage-rising synchronous rectification transistor M4 using a PMOS transistor, a PMOS transistor M5, an inductor L1, an output capacitor Co, a comparator 11, and a PFM/PWM control circuit 12.

The diode D2 is connected between the substrate gate and the drain of the voltage-falling switching transistor M1, and this diode is a parasitic diode which is produced when forming the voltage-falling switching transistor M1 on a semiconductor substrate.

All the circuit elements of the voltage rising/falling type switching regulator 1, except the inductor L1 and the output capacitor Co are integrated on a single IC (integrated circuit). This IC is provided with an input terminal Vdd which forms a power supply terminal, a ground terminal Vss, an output terminal Vout, and a set of terminals FBIN, BOLX, and BULX.

The voltage-falling switching transistor M1 corresponds to the voltage-falling switching element in the claims. The voltage-falling rectifier diode D1 corresponds to the voltage-falling rectifier element in the claims. The voltage-rising switching transistor M3 corresponds to the voltage-rising switching element in the claims. The voltage-rising synchronous rectification transistor M4 corresponds to the voltage-rising synchronous rectification switching element in the claims. The comparator 11 corresponds to the reverse current detecting part in the claims.

The resistors R1-R6, the capacitors C1-C4, the reference-voltage generating circuit 2, the operational amplifiers 3 and 4, the shift voltage generating circuit 5, the voltage-falling PWM comparator 6, the voltage-rising PWM comparator 7, the triangular wave oscillator 8, the voltage-falling output control circuit 9, the voltage rising output control circuit 10, and the PFM/PWM control circuit 12 correspond to the control circuit part in the claims.

The operational amplifier 3, the resistor R3, and the capacitor C2 correspond to an error amplifier part in the claims. The operational amplifier 4, the resistors R4-R6, the capacitors C3, C4, and the shift voltage generating circuit 5 correspond to the inverted amplifier part in the claims. The voltage-falling PWM comparator 6, the voltage-rising PWM comparator 7, the triangular wave oscillator 8, the voltage-falling output control circuit 9, the voltage rising output control circuit 10, and the PFM/PWM control circuit 12 correspond to the output control circuit part in the claims.

In the operational amplifier 3 which constitutes a part of the error amplifier, the proportional voltage Vfb which is derived from the output voltage Vo is inputted to the inverted input terminal thereof, and the reference voltage Vref is inputted to the non-inverted input terminal thereof.

The output terminal of the operational amplifier 3 is connected to the inverted input terminal of the operational amplifier 4 (which constitutes a part of the inverted amplifier) via the resistor R4, and the output terminal of the operational amplifier 3 is connected to the inverted input terminal of the voltage-falling PWM comparator 6. The resistor R3 and the capacitor C2 are used to perform phase compensation of the operational amplifier 3.

In the operational amplifier 4, the shift voltage Vs is inputted to the non-inverted input terminal thereof, and the series circuit of the resistor R5 and the resistor R6 is connected between the output terminal and the inverted input terminal of the operational amplifier 4. The capacitor C3 is connected to the resistor R4, and the capacitor C4 is connected to the resistor R5 in parallel, respectively. These circuit elements are used to perform phase compensation of the operational amplifier 4. The output terminal of the operational amplifier 4 is connected to the inverted input terminal of the voltage-rising PWM comparator 7.

The triangular wave voltage VC outputted from the triangular wave oscillator 8 is inputted to each of the non-inverted input terminal of the PWM comparator 6 and the non-inverted input terminal of the voltage-rising PWM comparator 7. The output signal SE of the voltage-rising PWM comparator 7 is inputted to the voltage rising output control circuit 10, and this voltage rising output control circuit 10 controls switching ON/OFF of the voltage-rising switching transistor M3 and the voltage-rising synchronous rectification transistor M4, respectively.

The output signal SD of the voltage-falling PWM comparator 6 is inputted to the voltage-falling output control circuit 9, and this voltage-falling output control circuit 9 controls switching ON/OFF of the voltage-falling switching transistor M1.

In the voltage-falling switching transistor M1, the source thereof is connected to the input terminal Vdd, and the drain thereof is connected to the cathode of the voltage-falling rectifier diode D1 and the terminal BULX, respectively.

The anode of the voltage-falling rectifier diode D1 is connected to the ground terminal Vss. The PMOS transistor M5 is connected between the input terminal Vdd and the substrate gate of the voltage-falling switching transistor M1, and a control signal pof from the voltage-falling output control circuit 9 is inputted to the gate of the PMOS transistor M5.

In the voltage-rising switching transistor M3, the source thereof is connected to the ground terminal Vss, and the drain thereof is connected to one end of the voltage-rising synchronous rectification transistor M4 and the terminal BOLX, respectively. The other end of the voltage-rising synchronous rectification transistor M4 is connected to the output terminal Vout. Each input terminal of the comparator 11 is connected to the ends of the voltage-rising synchronous rectification transistor M4, the comparator 11 detects a reverse current to the output current outputted from output terminal Vout, and the output terminal of the comparator 11 is connected to the voltage-falling output control circuit 9.

One end of the inductor L1 is connected to the connection point between the voltage-rising switching transistor M3 and the voltage-rising synchronous rectification transistor M4 via the terminal BOLX, and the other end of the inductor L1 is connected to the connection point between the voltage-falling switching transistor M1 and the voltage-falling rectifier diode D1 via the terminal BULX.

The output capacitor Co is connected between the output terminal Vout and the ground terminal Vss. Each of the output voltages VA and VB of the operational amplifiers 3 and 4, and the triangular wave voltage VC from the triangular wave oscillator 8 are inputted to the PFM/PWM control circuit 12, respectively. The output signal from the PFM/PWM control circuit 12 is inputted to each of the voltage-falling output control circuit 9 and the voltage rising output control circuit 10, respectively.

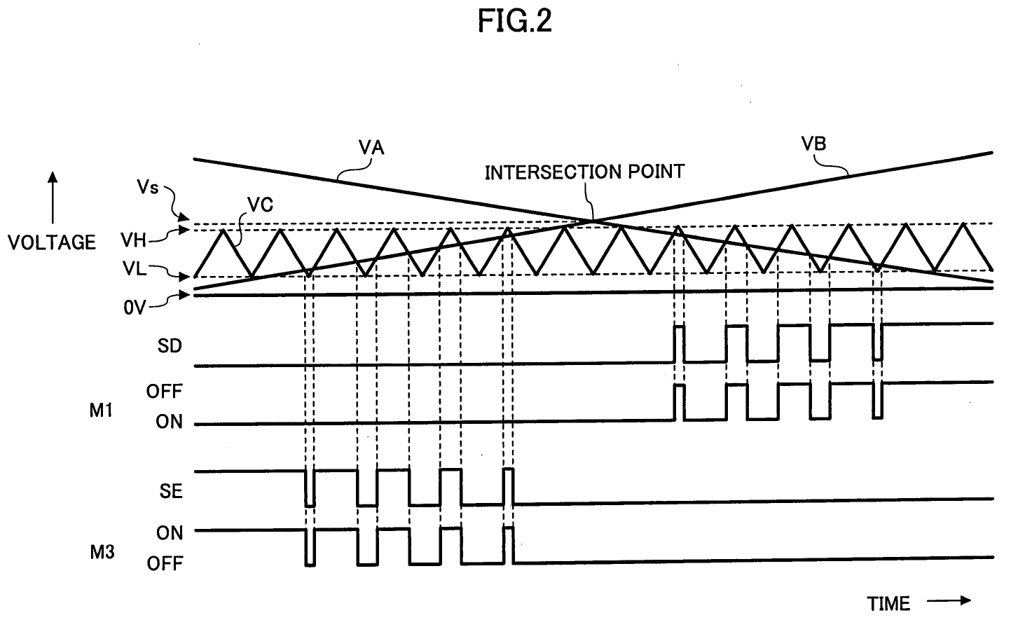

FIG. 2 is a timing chart for explaining operation of the voltage rising/falling type switching regulator 1 of FIG. 1. As shown in FIG. 2, the operational amplifier 3 amplifies and outputs a voltage difference between the proportional voltage Vfb and the reference voltage Vref.

The output voltage VA of the operational amplifier 3 is inputted to the voltage-falling PWM comparator 6 which performs the voltage-falling control. The capacitance of the capacitor C2 which performs phase compensation may be small, and it is possible to perform phase compensation without scarifying high frequency characteristic so much, and it is possible to attain control with high-speed response.

Moreover, the output voltage VA of the operational amplifier 3 is inverted by the inverted amplifier and the output voltage VB is supplied to the voltage-rising PWM comparator 7. The operational amplifier 4 which constitutes the inverted amplifier is used for voltage rising control. The capacitance of the capacitor for phase compensation can be increased, and the high frequency characteristic operational amplifier 4 is decreased from that of the operational amplifier 3.

The triangular wave voltage VC is inputted to each of the voltage-falling PWM comparator 6 and the voltage-rising PWM comparator 7, respectively. The output voltage VA of the operational amplifier 3 and the output voltage VB of the operational amplifier 4 are subjected to PWM modulation so that the signal of each output voltage has a pulse width proportional to its voltage value, thereby generating a control pulse signal which controls the voltage-falling switching transistor M1 and the voltage-rising switching transistor M3.

As shown in FIG. 2, if the output voltage VA of the operational amplifier 3 falls, then the output voltage VB of the operational amplifier 4 rises. It is assumed in the example of FIG. 2 that the lower limit voltage of the triangular wave voltage VC from the triangular wave oscillator 8 is set to VL, and the upper limit voltage thereof is set to VH.

When the output voltage VA of the operational amplifier 3 is above the upper limit voltage VH and the output voltage VB of the operational amplifier 4 is below the lower limit voltage VL, the output signal SD of the voltage-falling PWM comparator 6 is set to the low level, and the output signal SE of the voltage-rising PWM comparator 7 is set to the high level. In this state, the voltage-falling switching transistor M1 is set to ON 100%.

Moreover, the voltage-rising switching transistor M3 is set to ON 100%. In this state, the PWM control is shifted to the PFM control by the PFM/PWM control circuit 12, and under the PFM control the voltage-rising switching transistor M3 is switched OFF in a relatively short time at a predetermined frequency, and the voltage-rising switching transistor M3 is not set to ON 100%.

The output voltage VA of the operational amplifier 3 falls further. When the output voltage VA is above the upper limit voltage VH of the triangular wave voltage VC and the output voltage VB of the operational amplifier 4 turns into an intermediate voltage between the lower limit voltage VL and the upper limit voltage VH of the triangular wave voltage VC, the output signal SD of the voltage-falling PWM comparator 6 is set to the low level and the voltage-falling switching transistor M1 is set to ON 100%. However, the output signal SE of the voltage-rising PWM comparator 7 is repeatedly set to the high level or the low level. Switching ON/OFF of the voltage-rising switching transistor M3 is controlled accordingly, so that voltage-rising operation is performed. Thus, the output voltage Vo which is higher than the input voltage Vin is outputted.

As is apparent from FIG. 2, the on-duty cycle of the voltage-rising switching transistor M3 becomes small as the output voltage VB becomes high. If the output voltage VA of the operational amplifier 3 falls further, the output voltage VB of the operational amplifier 4 is above the upper limit voltage VH of the triangular wave voltage VC, so that the output voltage VA of the operational amplifier 3 and the output voltage VB of the operational amplifier 4 intersect each other at the point of intersection indicated in FIG. 2 and they are at the same voltage.

At this time, both the output signal SD of the voltage-falling PWM comparator 6 and the output signal SE of the voltage-rising PWM comparator 7 are set to the low level, so that the voltage-falling switching transistor M1 is set to ON 100% and the voltage-rising switching transistor M3 is set to OFF 100%. Namely, the voltage rising/falling type switching regulator 1 is in the non-controlled state in which the input voltage Vin is outputted from the output terminal Vout without change.

The output voltage VA of the operational amplifier 3 falls further. When the output voltage VA is at an intermediate the voltage between the upper limit voltage VH and the lower limit voltage VL of the triangular wave voltage VC, the output signal SD of the voltage-falling PWM comparator 6 is repeatedly set to the high level or the low level. The output signal SE of the voltage-rising PWM comparator 7 is set to the low level. In this state, the voltage-rising switching transistor M3 is set to OFF 100%, and the switching ON/OFF of the voltage-falling switching transistor M1 is controlled so that the output voltage Vo which is lower than the input voltage Vin is outputted. As is apparent from FIG. 2, the on-duty cycle of the voltage-falling switching transistor M1 becomes small as the output voltage VA becomes small.

The output voltage VA of the operational amplifier 3 falls further. When the output voltage VA is below the lower limit voltage VL of the triangular wave voltage VC, the output signal SD of the voltage-falling PWM comparator 6 is set to the high level, and the voltage-falling switching transistor M1 is set to OFF 100%.

In the state where the voltage-falling switching transistor M1 is set to OFF 100% in this embodiment, the PWM control is shifted to the PFM control by the PFM/PWM control circuit 12, and the voltage-falling switching transistor M1 is switched ON in a relatively small time at a predetermined frequency. For this reason, the voltage-falling switching transistor M1 is not set to OFF 100%.

Next, the output voltage VA of the operational amplifier 3 and the output voltage VB of the operational amplifier 4 when shifting between voltage-rising operation and voltage-falling operation switching occurs will be explained.

The output voltage VB of the operational amplifier 4 when the combined resistance value of the resistors R5 and R6 is equal to the resistance of the resistor R4 of the inverted amplifier satisfies the following formula:

VB=2×Vs−VA (1)

When shifting between voltage-rising operation and voltage-falling operation occurs, the output voltage VA of the operational amplifier 3 is equal to the output voltage VB of the operational amplifier 4. If the condition VB=VA is substituted into the above formula (1), then the condition VA=VB=Vs is satisfied. This shows that the shift voltage Vs is a specific voltage value at the time of shifting between voltage-rising operation and voltage-falling operation.

In the present embodiment, the shift voltage Vs is set to be equal to or slightly higher than as the upper limit voltage VH of the triangular wave voltage VC. Accordingly, the mode of operation can be switched between voltage-rising operation and voltage-falling operation through the non-control state in which neither voltage-rising operation nor voltage-falling operation is performed, and it is possible to attain smooth shifting operation.

In the above-mentioned embodiment, the output voltage VA of the operational amplifier 3 starts increasing from 0 V upon power up of the switching regulator, and the region in which voltage-falling operation is performed is always present. The ON state of the voltage-falling switching transistor M1 does not continue too long, and there is no need to provide a soft-start circuit in order to prevent occurrence of a large rush current.

On the other hand, at the time of voltage-rising operation, in the voltage-falling output control circuit 9, each of the gate of the voltage-falling switching transistor M1 and the gate of the PMOS transistor M5 is set to the low level, and both the voltage-falling switching transistor M1 and the PMOS transistor M5 are switched ON. Since the PMOS transistor M5 is switched ON, the substrate gate of the voltage-falling switching transistor M1 is connected to the source of the voltage-falling switching transistor M1. The voltage-rising output control circuit 10 controls the gate voltage of each of the voltage-rising switching transistor M3 and the voltage-rising synchronous rectification transistor M4, so that the voltage-rising switching transistor M3 and the voltage-rising synchronous rectification transistor M4 are switched ON and OFF complementarily.

When the voltage rising/falling type switching regulator 1 operates in the continuous mode, the current flows through the voltage-rising synchronous rectification transistor M4 in the direction from the terminal BOLX to the output terminal Vout. The voltage at one end of the voltage-rising synchronous rectification transistor M4 near the terminal BOLX is relatively high, and the voltage at the other end of the voltage-rising synchronous rectification transistor M4 near the output terminal Vout is relatively low. For this reason, the output terminal of the comparator 11 is set to the low level.

If the voltage rising/falling type switching regulator 1 operates in the discontinuous mode and all the energy accumulated in the inductor L1 is discharged, a reverse current flows through the voltage-rising synchronous rectification transistor M4 in the backward direction from the output terminal Vout to the terminal BOLX. The voltage at one end of the voltage-rising synchronous rectification transistor M4 near the output terminal Vout is relatively high, and the voltage at the other end of the voltage-rising synchronous rectification transistor M4 near the terminal BOLX is relatively low. For this reason, the output terminal of the comparator 11 is set to the high level.

When the output terminal of the comparator 11 is set to the high level, in the voltage-falling output control circuit 9, each of the gate of the voltage-falling switching transistor M1 and the gate of the PMOS transistor M5 is set to the high level, respectively, and the voltage-falling switching transistor M1 and the PMOS transistor M5 are switched OFF respectively and they are set in a cut-off state.

As a result, the path of current which flows from the output terminal Vout to the input terminal Vdd in the opposite direction is in a cut-off state, and it is possible to prevent occurrence of a reverse current.

In the above-mentioned embodiment, the PMOS transistor M5 serves to prevent occurrence of a reverse current flowing via the parasitic diode D2 formed between the drain and the substrate gate of the voltage-falling switching transistor M1. If the parasitic diode D2 which causes reverse current to occur in the circuit element is used in the voltage-falling switching transistor M1, the PMOS transistor M5 is no longer unnecessary to be used.

Another method is conceivable in which the voltage-rising synchronous rectification transistor M4 is switched OFF if a reverse current occurs and the output terminal of the comparator 11 is set to the high level. However, in such a method, both the voltage-rising switching transistor M3 and the voltage-falling switching transistor M1 are switched OFF when a reverse current occurs at the time of the voltage-falling operation. If the voltage-rising switching transistor M4 is switched OFF in such a state, the inverted input terminal of the comparator 11 is set in the floating state. Since the output terminal of the comparator 11 becomes unstable, it is difficult to prevent occurrence of a reverse current effectively.

In order to avoid the problem, it is necessary to add a temporary storage circuit between the output terminal of the comparator 11 and the voltage-falling output control circuit 9. And it is necessary to store the first-occurrence high level in the output terminal of the comparator 11.

Furthermore, the circuit for resetting the memory content of the temporary storage circuit for every clock cycle of the voltage rising/falling type switching regulator 1 is needed. For this reason, the circuit size will be increased, and this method is not suitable.

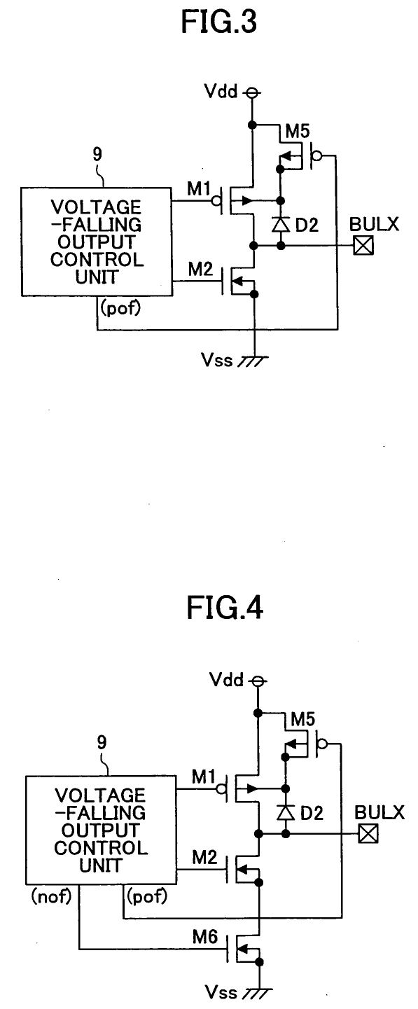

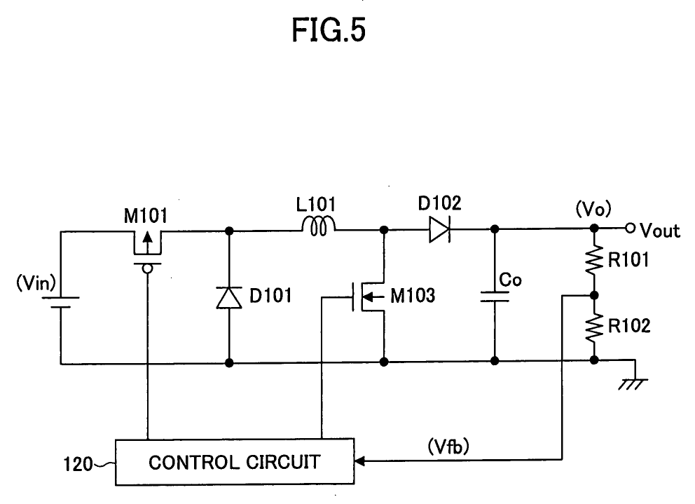

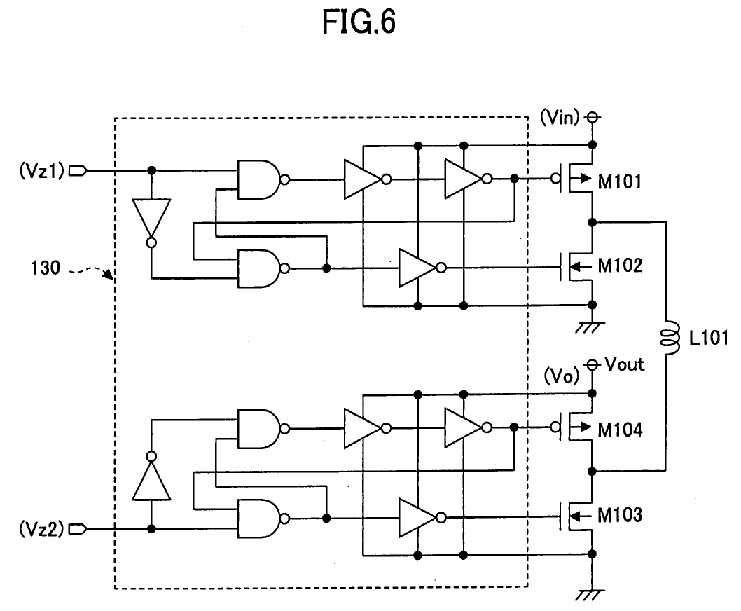

Next, the present invention is applicable also to the voltage rising/falling type switching regulator of synchronous rectification. In this case, as shown in FIG. 3, the voltage-falling synchronous rectification transistor M2 which includes an NMOS transistor may be used instead of the voltage-falling rectifier diode D1 of FIG. 1.

In FIG. 3, only a difference between the composition of FIG. 1 and the composition of FIG. 3 is illustrated, and the elements which are the same corresponding elements in FIG. 1 are omitted.

In the voltage rising/falling type switching regulator of synchronous rectification of FIG. 3, the drain of the voltage-falling synchronous rectification transistor M2 is connected to the drain of the voltage-falling switching transistor M1, and the source of the voltage-falling synchronous rectification transistor M2 is connected to the ground terminal Vss. The gate of the voltage-falling synchronous rectification transistor M2 is connected to the voltage-falling output control circuit 9.

Switching ON/OFF of each of the voltage-falling synchronous rectification transistor M2 and the voltage-falling switching transistor M1 is controlled complementarily according to a control signal from the voltage-falling output control circuit 9.

If a reverse current occurs and the output terminal of the comparator 11 is set to the high level, the voltage-falling output control circuit 9 switches OFF each of the voltage-falling synchronous rectification transistor M2, the voltage-falling switching transistor M1, and the PMOS transistor M5, respectively, so that they are set in a cut-off state.

Accordingly, a reverse current does not flow into the ground terminal Vss and does not flow into the input terminal Vdd, and it is possible to prevent occurrence of a reverse current.

In the composition of FIG. 3, if a reverse current is detected, the voltage-falling synchronous rectification transistor M2 is switched OFF. Alternatively, the NMOS transistor M6 may be connected to the voltage-falling synchronous rectification transistor M2 in series. In such alternative embodiment, if a reverse current is detected, the NMOS transistor M6 may be switched OFF and set in a cut-off state. The composition in such alternative embodiment will be explained with reference to FIG. 4.

In FIG. 4, the NMOS transistor M6 is connected between the source of the voltage-falling synchronous rectification transistor M2 and the ground terminal Vss, and a control signal nof from the voltage-falling output control circuit 9 is inputted to the gate of the NMOS transistor M6.

The NMOS transistor M6 is normally switched ON so that it is set in a conduction state. If a reverse current occurs and the output terminal of the comparator 11 is set to the high level, the voltage-falling output control circuit 9 switches OFF the NMOS transistor M6, the voltage-falling switching transistor M1, and the PMOS transistor M5, respectively, so that they are set in a cut-off state.

For this reason, a reverse current does not flow into the ground terminal Vss and does not flow into the input terminal Vdd, and it is possible to prevent occurrence of a reverse current.

In the voltage rising/falling type switching regulator in the previously described embodiment, the voltage at one end of the voltage-rising synchronous rectification transistor M4 and the voltage at the other end thereof are compared using the comparator 11, and the direction of current flowing through the voltage-rising synchronous rectification transistor M4 is detected in order to detect whether a reverse current occurs. The voltage-falling switching transistor M1 and the PMOS transistor M5 are switched OFF, respectively, if it is detected that a reverse current occurs. Accordingly, it is possible to provide a voltage rising/falling type switching regulator which uses MOS transistors as rectifier elements and is arranged with simple circuit composition to prevent occurrence of a reverse current effectively.

The present invention is not limited to the above-described embodiments, and variations and modifications may be made without departing from the scope of the present invention.

The present application is based on and claims the benefit of priority of Japanese patent application No. 2007-011074, filed on Jan. 22, 2007, the contents of which are incorporated herein by reference in their entirety.

1. A voltage rising/falling type switching regulator which changes an input voltage from an input terminal to a predetermined voltage through voltage rising/falling operation using an inductor and outputs a resulting voltage from an output terminal, comprising:
a voltage-falling switching element which is switched in response to a control signal to perform voltage-falling operation and charge the inductor by the input voltage;
a voltage-falling rectifier element which discharges the inductor to perform voltage-falling operation;
a voltage-rising switching element which is switched in response to a control signal to perform voltage-rising operation and charge the inductor by the input voltage;
a voltage-rising synchronous rectification switching element which is switched in response to a control signal to perform voltage-rising operation and discharge the inductor;
a control circuit part causing the voltage-falling switching element to be switched to perform voltage-falling operation, and causing the voltage-rising switching element and the voltage-rising synchronous rectification switching element to be switched to perform voltage-rising operation, so as to set the resulting voltage from the output terminal to the predetermined voltage; and
a reverse current detecting part detecting a reverse current which flows backward from the output terminal to the voltage-rising synchronous rectification switching element,
wherein the control circuit part is arranged so that the voltage-falling switching element is switched ON and set in a conduction state at the time of voltage-rising operation, the voltage-rising synchronous rectification switching element is switched ON and set in a conduction state at the time of voltage-falling operation, and, if the reverse current detecting part detects the reverse current, the voltage-falling switching element is switched OFF and set in a cut-off state.

2. The voltage rising/falling type switching regulator of claim 1, wherein the voltage-falling switching element is an MOS transistor, a first switching element is provided to make connection between the input voltage and a substrate gate of the MOS transistor, and the control circuit part is arranged to switch the first switching element OFF and set the first switching element in a cut-off state if the reverse current detecting part detects the reverse current.

3. The voltage rising/falling type switching regulator of claim 2, wherein the first switching element is an MOS transistor of a type which is the same as a type of the voltage-falling switching element.

4. The voltage rising/falling type switching regulator of claim 1, wherein the voltage-rising synchronous rectification switching element is an MOS transistor, and the reverse current detecting part detects the reverse current based on a voltage difference between two ends of the MOS transistor.

5. The voltage rising/falling type switching regulator of claim 1, wherein the voltage-falling rectifier element is a diode.

6. The voltage rising/falling type switching regulator of claim 1, wherein the voltage-falling rectifier element is a voltage-falling synchronous rectification switching element which is switched in response to a control signal to perform voltage-falling operation and discharge the inductor, and the control circuit part is arranged to cause the voltage-falling switching element and the voltage-falling synchronous rectification switching element to be switched to perform voltage-falling operation, so as to set the resulting voltage from the output terminal to the predetermined voltage, and, if the reverse current detecting part detects the reverse current, the voltage-falling synchronous rectification switching element is switched OFF and set in a cut-off state.

7. The voltage rising/falling type switching regulator of claim 1, wherein the voltage-falling rectifier element is a voltage-falling synchronous rectification switching element which is switched in response to a control signal to perform voltage-falling operation and discharge the inductor, and a second switching element is connected in series to the voltage-falling synchronous rectification switching element and switched in response to a control signal inputted to a control electrode, and the control circuit part is arranged so that, if the reverse current detecting part detects the reverse current, the second switching element is switched OFF and set in a cut-off state.

8. The voltage rising/falling type switching regulator of claim 5, wherein the control circuit part comprises:
an error amplifier part which outputs an amplified signal of a voltage difference between a proportional voltage proportional to the resulting voltage from the output terminal, and a predetermined reference voltage;
an inverted amplifier part which outputs an inverted amplified signal of an output signal from the error amplifier part; and
an output control circuit part which causes the voltage-falling switching element to be switched in response to the output signal from the error amplifier part to perform voltage-falling operation, and causes the voltage-rising switching element and the voltage-rising synchronous rectification switching element to be switched in response to the output signal from the error amplifier part to perform voltage-rising operation, so as to set the resulting voltage from the output terminal to the predetermined voltage.

9. The voltage rising/falling type switching regulator of claim 6, wherein the control circuit part comprises:
an error amplifier part which outputs an amplified signal of a voltage difference between a proportional voltage proportional to the resulting voltage from the output terminal, and a predetermined reference voltage;
an inverted amplifier part which outputs an inverted amplified signal of an output signal from the error amplifier part; and
an output control circuit part which causes the voltage-falling switching element and the voltage-falling synchronous rectification switching element to be switched in response to the output signal from the error amplifier part to perform voltage-falling operation, and causes the voltage-rising switching element and the voltage-rising synchronous rectification switching element to be switched in response to the output signal from the error amplifier part to perform voltage-rising operation, so as to set the resulting voltage from the output terminal to the predetermined voltage.

10. The voltage rising/falling type switching regulator of claim 8, wherein the output control circuit part is arranged so that, when an output voltage of the error amplifier part and an output voltage of the inverted amplifier part are equal to each other, the output control circuit part controls switching of the voltage-falling switching element and the voltage-rising switching element so as to set an on-duty cycle of the voltage-falling switching element to 100% and set an on-duty cycle of the voltage-rising switching element to 0%.

11. The voltage rising/falling type switching regulator of claim 10, wherein the output control circuit part comprises:
a triangular wave oscillator which generates and outputs a predetermined triangular wave signal;
a voltage-falling output control circuit which controls switching of the voltage-falling switching element based on a result of comparison between the triangular wave signal and the output signal from the error amplifier part;
a voltage-rising output control circuit which controls switching of the voltage-rising switching element and the voltage-rising synchronous rectification switching element, respectively, based on a result of comparison between the triangular wave signal and the output signal from the inverted amplifier part;
wherein, when the output voltage of the error amplifier part and the output voltage of the inverted amplifier part are equal to each other, the output voltage of each amplifier part exceeds an upper limit voltage of the triangular wave signal.

12. The voltage rising/falling type switching regulator of claim 8, wherein the inverted amplifier part comprises a shift voltage generating circuit generating a predetermined shift voltage which is applied to an output signal which is inverted and amplified.

13. The voltage rising/falling type switching regulator of claim 1, wherein the voltage-falling switching element, the voltage-falling rectifier element, the voltage-rising switching element, the voltage-rising synchronous rectifier element, the control circuit part, and the reverse current detecting part are integrated on a single IC.

14. A reverse current prevention method of a voltage rising/falling type switching regulator which changes an input voltage from an input terminal to a predetermined voltage through voltage rising/falling operation using an inductor and outputs a resulting voltage from an output terminal, the voltage rising/falling type switching regulator including:
a voltage-falling switching element which is switched in response to a control signal to perform voltage-falling operation and charge the inductor by the input voltage;
a voltage-falling rectifier element which discharges the inductor to perform voltage-falling operation;
a voltage-rising switching element which is switched in response to a control signal to perform voltage-rising operation and charge the inductor by the input voltage; and
a voltage-rising synchronous rectification switching element which is switched in response to a control signal to perform voltage-rising operation and discharge the inductor;
wherein the voltage-falling switching element is switched to perform voltage-falling operation, and the voltage-rising switching element and the voltage-rising synchronous rectification switching element are switched to perform voltage-rising operation, so as to set the resulting voltage from the output terminal to the predetermined voltage, the reverse current prevention method comprising:
switching ON the voltage-falling switching element to set the voltage-falling switching element in a conduction state at the time of voltage-rising operation;
switching ON the voltage-rising synchronous rectification switching element to set the voltage-rising synchronous rectification switching element in a conduction state at the time of voltage-falling operation;
detecting a reverse current which flows backward from the output terminal to the voltage-rising synchronous rectification switching element; and
switching OFF the voltage-falling switching element and setting the voltage-falling switching element in a cut-off state, if the reverse current is detected.

15. The reverse current prevention method of claim 14, wherein the voltage-falling rectifier element is a voltage-falling synchronous rectification switching element which is switched in response to a control signal to perform voltage-falling operation and discharge the inductor, and, if the reverse current is detected, the voltage-falling switching element and the voltage-falling synchronous rectification switching element are switched OFF and set in a cut-off state respectively.

16. The reverse current prevention method of claim 14, wherein the voltage-falling rectifier element is a voltage-falling synchronous rectification switching element which is switched in response to a control signal to perform voltage-falling operation and discharge the inductor, and a second switching element is connected in series to the voltage-falling synchronous rectification switching element and switched in response to a control signal inputted to a control electrode, and, if the reverse current is detected, the voltage-falling switching element and the second switching element are switched OFF and set in a cut-off state.

17. The reverse current prevention method of claim 14, wherein the voltage-falling switching element is an MOS transistor, a first switching element is provided to make connection between the input voltage and a substrate gate of the MOS transistor, and, if the reverse current is detected, the first switching element is switched OFF and set in a cut-off state.

18. The reverse current prevention method of claim 14, wherein the voltage-rising synchronous rectification switching element is an MOS transistor and the reverse current is detected based on a voltage difference between two ends of the MOS transistor.
